(19) United States
(12) Patent Application Publication
(10) Pub. No.: US 2013/0343751 A1
(43) Pub. Date: Dec. 26, 2013

(54) Optical Receiver with a Wide Power Sensitivity Dynamic Range

(71) Applicant: Pavel Mamyshev, Morganville, NJ (US)

(72) Inventor: Pavel Mamyshev, Morganville, NJ (US)

(21) Appl. No.: 13/689,215

(22) Filed: Nov. 29, 2012

Related U.S. Application Data
(60) Provisional application No. 61/663,551, filed on Jun. 23, 2012.

(51) Int. Cl. H04B 10/61

(52) U.S. Cl. CPC H04B 10/61
USPC 398/38; 398/202

(57) ABSTRACT

An optical receiver system includes a power adjustment device, an optical receiver, and a controller. The power adjustment device adjusts the power of an optical input signal in accordance with adjustment instructions. The optical receiver converts the power-adjusted optical input signal into an electrical signal that corresponds to a desired channel of the optical input signal. The optical receiver includes an electronic amplifier that amplifies the electrical signal using a gain value, and the amplified electrical signal preferably operates around a voltage value Vₒₚₜ. The controller determines adjustment instructions such that the power adjustment device adjusts the optical input signal to a target optical power level that corresponds to Vₒₚₜ for the amplified electrical signal, wherein the adjustment instructions are derived from the amplified electrical signal.

### CROSS-REFERENCE TO RELATED APPLICATION(S)

This application claims priority under 35 U.S.C. §119(e) to U.S. Provisional Patent Application Ser. No. 61/663,551, titled “Optical Receiver with a Wide Power Sensitivity Dynamic Range,” filed on Jun. 23, 2012. The subject matter of the foregoing is incorporated herein by reference in its entirety.

### BACKGROUND

1. Field of the Invention

This invention relates generally to optical receivers, and more particularly, to controlling power levels at the output of an optical receiver using feedback mechanisms.

2. Description of the Related Art

An optical receiver typically includes a photodetector followed by a trans-impedance amplifier (“TIA”). The output of the trans-impedance amplifier goes to an analog-to-digital convertor (“ADC”), for conversion to digital form followed by subsequent digital signal processing. For the optimum operation of the ADC (which impacts the overall performance of the receiver), the signal voltage swing at the ADC input should be close to some optimum value Vₒₚₜ. Both higher and lower voltages can cause performance degradation. The voltage should be kept close to the optimum even as the strength of the optical input signal changes including in the presence of fast optical signal transients at the receiver input. To maintain operation in the optimal regime, the gain of the TIA may be controlled to provide the desired output signal voltage close to Vopt.

However, for many reasons, the traditional scheme has a limited dynamic range with respect to receiver input optical signal power. First, the TIA gain range is typically limited and thus cannot compensate for a large variation of the optical input signal. Second, the receiver performance is often optimal only in a limited range of the TIA input signal, i.e. high penalties exist when the signal at the TIA input varies in a wide range. Third, if a coherent receiver operates in the optical receiver tuning mode (“ORT” mode, or “multi-channel” mode), multiple wavelength division multiplexed (“WDM”) channels are present at the input of the receiver, and the desired channel(s) is selected by an appropriate tuning of the local oscillator (“LO”) laser. In such a mode, the performance often will be optimal only in a region close to a specific value of the optical power of the selected channel(s). Fourth, coherent receivers with single-ended (e.g., non-differential) photodetectors can have high penalties when the input signal is high because of the direct-detection contribution to the signal. As a result, the low-penalty dynamic range is limited even in a single-channel operation.

### SUMMARY

An optical receiver system includes a power adjustment device, an optical receiver, and a controller. The power adjustment device adjusts the power of an optical input signal in accordance with adjustment instructions. The receiver converts the power-adjusted optical input signal into an electrical output signal that corresponds to a desired channel of the optical input signal. For example, the optical input signal might be a multi-channel input signal and the electrical output signal may correspond to a channel selected from the multiple channels. The optical receiver preferably includes an electronic amplifier that produces the electrical output signal, which preferably operates around a voltage value Vₒₚₜ. For example, the preferred voltage value Vₒₚₜ may be the value that minimizes an OSNR penalty for the optical receiver system. The controller determines adjustment instructions in response to the electrical output signal. The adjustment instructions cause the power adjustment device to adjust the optical input signal to a target optical power level that corresponds to the preferred output voltage Vₒₚₜ.

Other aspects of the disclosure include methods corresponding to the devices and systems described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of an example embodiment of an optical receiver system configured to operate as a fast optical loop feedback receiver (“Rx”) control system.

FIG. 2 is a flow diagram illustrating an example process performed by an optical receiver system operating as a fast optical loop feedback Rx control system.

FIG. 3 is a graph showing multi-channel operation of an optical receiver system with and without fast variable optical attenuator (“VOA”) feedback Rx control.

FIG. 4 is a block diagram of an example embodiment of an optical receiver system configured to operate as a fast optical loop feedback and fast AMP Rx control system.

FIG. 5 is a flow diagram illustrating an example process performed by an optical receiver system operating as a fast optical loop feedback and fast AMP Rx control system.

FIG. 6 is a graph comparing multi-channel operation of a fast VOA feedback Rx control system with a fast VOA and fast AMP Rx feedback control system.

FIG. 7 is a block diagram of an example embodiment of an optical receiver system configured to operate as a slow optical loop and fast electrical loop feedback Rx control system.

FIG. 8 is a flow diagram illustrating an example process performed by an optical receiver system operating as a slow optical loop and fast electrical loop feedback Rx control system.

FIG. 9 is a graph showing multi-channel operation of a coherent Rx with and without slow VOA feedback Rx control.

FIG. 10 is a block diagram of an example embodiment of an optical receiver system utilizing single ended electronic amplifiers.

FIG. 11 3 is a graph showing multi-channel operation of a coherent Rx using single-ended electronic amplifiers with and without slow VOA feedback Rx control.

FIG. 12A is a block diagram of an example embodiment of a front end of an optical receiver system where an output of a LO laser is adjusted using a power adjustment device.

FIG. 12B is a block diagram of an example embodiment of a front end of an optical receiver system where an output of a LO laser is adjusted by varying the LO laser power itself.

FIG. 12C is a block diagram of an example embodiment of a front end of an optical receiver system where the output of a LO laser is adjusted by varying the LO laser power itself and the power of the optical input signal is adjusted using a power adjustment device.

FIG. 12D is a block diagram of an example embodiment of a front end of an optical receiver system where the output of an LO laser is adjusted by varying the power of the LO laser and by varying a power adjustment device.

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### DETAILED DESCRIPTION OF THE PREFERRED EMBODIMENTS

Systems and methods are presented to better maintain operating voltages at a receiving device in an optimal range which corresponds to the best performance. The receiving device is a device which receives one or more sensor output signals from on optical receiver. For example, the receiving device may be an analog-to-digital converter (“ADC”), decision circuit, demodulator, or other device with a desired voltage range for input signals. When the electric signals are outside an intended operating range it may cause reduced performance of the receiving device.

In some of the embodiments described below “fast” feedback loops, “slow” feedback loops, or some combination thereof are implemented. Fast and slow refer to the relative timescales on which a particular feedback loop operates. For example, a fast feedback loop may have a response time in the microseconds or sub-microseconds, whereas a slow feedback loop may have a response time in the milliseconds. However, the exact time scale of a response time for a particular fast or slow loop is application dependent, and may vary for different applications.

### Fast Optical Loop Feedback Receiver Control

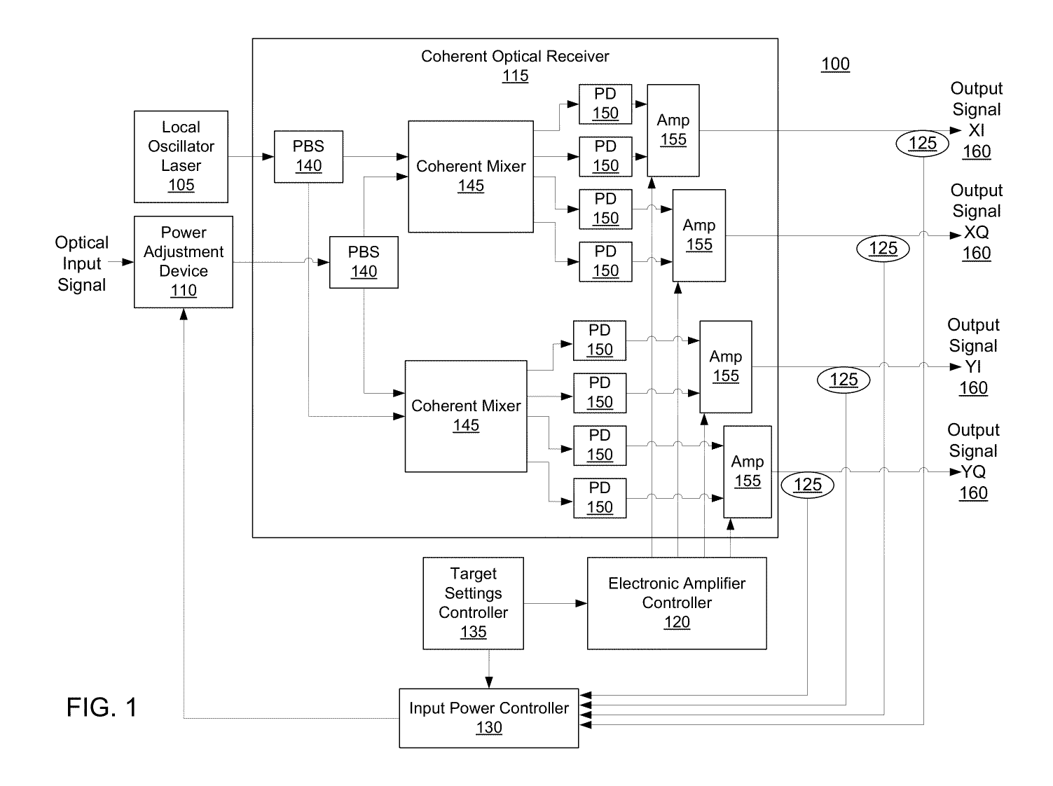

FIG. 1 is a block diagram of an example embodiment of an optical receiver system 100 configured to operate as “a fast optical loop feedback receiver control system.” As shown in exemplary FIG. 1, the optical receiver system 100 comprises a local oscillator (“LO”) laser 105, a power adjustment device 110, a coherent optical receiver 115, an electronic amplifier controller 120, electronic signal monitors 125, an input power controller 130, and a target settings controller 135. This embodiment describes “a fast optical loop feedback receiver (“Rx”) control system” where output signals that correspond to a specific target channel act as a feedback mechanism to control the power of the optical signal entering the coherent optical receiver 115. As used herein, “fast VOA feedback Rx control” refers to an embodiment of optical receiver system 100 where the power adjustment device 110 is a variable optical attenuator (“VOA”).

LO laser 105 is a device configured to generate a coherent reference optical field of stable phase that is mixed with an optical signal to extract certain information (e.g., phase, amplitude, etc.) from the optical signal. Additionally, when the optical signal contains multiple channels, for example, WDM channel selection may be achieved by tuning the output of LO laser 105 close to the desired WDM channel. Additionally, in some embodiments, one or more aspects (power level, frequency, etc.) of the output of LO laser 105 may be dynamically modified. For example, if the optical input signal contains multiple channels, optical receiver system 100 may be configured to tune the output of LO laser 105 such that a particular channel is selected as part of the mixing process.

Power adjustment device 110 may be, for example, a VOA or a variable gain optical amplifier. The power adjustment device 110 is coupled to the input power controller 130 and may be configured to adjust (e.g., attenuate or amplify) the power level of the optical input signal in accordance with adjustment instructions received from the input power controller 130. In embodiments, where the power adjustment device 110 is a VOA, the power adjustment device 110 is configured to attenuate the input optical signal in accordance with adjustment instructions. Likewise, in embodiments where the power adjustment device 110 is a variable gain optical amplifier, the gain is configured in accordance with adjustment instructions. The adjusted optical signal then passes to the coherent optical receiver 115.

Coherent optical receiver 115 is configured to receive the power-adjusted optical signal and a tuned output of LO laser 105, and is configured to output four electronic output signals 160 that are associated with the desired or selected optical channel. Beating between the output of LO Laser 105 and the power-adjusted optical signal ensures that only the desired optical channel (i.e., channel operating at the same frequency as the output of the LO Laser 105) is amplified. All other channels with frequencies far from the frequency of the output of the LO Laser 105 are attenuated at the electrical amplifiers 155. The coherent optical receiver 115 is configured to separate the adjusted signal into orthogonal polarization components (e.g., X/Y polarized waves) and orthogonal phase components (e.g., I/Q channels; I: in-phase component, Q: quadrature component), which are converted into four high-speed differential electrical signals, i.e., electrical output signals 160. In this embodiment, the coherent optical receiver 115 includes polarizing beam splitters (“PBSs”) 140, coherent mixers 145, photodetectors (“PDs”) 150, and electronic amplifiers (“AMPs”) 155. Additionally, in some embodiments, one or more digital filters (not shown) may be used to remove one or more channels.

The coherent optical receiver 115 uses the PBSs 140 to split the power-adjusted optical signal and the tuned output of LO laser 105 into respective pairs of orthogonally polarized signals (e.g., X and Y). Optical signals of the same polarization are routed to the same coherent mixer 145. Thus, in this embodiment, one coherent mixer 145 mixes X polarized optical signals and the other coherent mixer 145 mixes Y polarized optical signals. Each coherent mixer 145 outputs two pairs of differential optical signals, where each pair is associated with a particular phase component (e.g., I or Q). Due to the mixing process the resulting optical signals are tuned to the selected channel. The resulting optical signals are then converted into corresponding electronic signals using PDs 150. PDs 150 may be, for example, p-i-n diodes.

The electronic signals are then amplified using the AMPs 155 and outputted as the electrical output signals 160. An AMP 155 may be, for example, a trans-impedance amplifier, or some other differential electronic amplifier. Each AMP 155 has an associated gain value that determines the amount of electronic amplification applied to its respective signal. In this embodiment, assuming the AMPs 155 are trans-impedance amplifiers the gain (in Ohms) may be adjusted between 100 Ohm to 10 KOhm, however, in other embodiments the gain values may be higher or lower. The gain value for each AMP 155 may be set by the electronic amplifier controller 120. The electronic amplifier controller 120 may be configured to maintain each AMP 155 at the same gain value, e.g., a target value, G_{AMP}_{_{—}}ₛₑₜ. G_{AMP}_{_{—}}ₛₑₜ may be determined during calibration and corresponds to the optical target power of the selected channel immediately after the power adjustment device 110, P_{Ds}_{_{—}}_{ch}_{_{—}}_{tgt}. Alternatively, the electronic amplifier controller 120 may be configured to set each AMP 155 independent from each other. For example, the gain values for one or more of the AMP 155s may be different from each other. Additionally, the electronic amplifier controller 120 may be configured to dynamically adjust the gain values for each AMP 155 during operation of the coherent optical receiver 115.

Electronic signal monitors 125 monitor each of the electrical output signals 160 and produce a corresponding sensor output signal. Each of the output signals 160 and their corresponding sensor output signals are proportional to the selected channel power and to the power of the LO laser 105 output. Additionally, each of the output signals 160 corresponds to the selected channel and is fairly independent of, and much larger than, the power levels of other electrical channels which correspond to other WDM channels attenuated as a result of the coherent mixing process described above. Each electronic signal monitor 125 is coupled to the input power controller 130. Alternatively, in some embodiments, one or more of the electronic signal monitors 125 may be coupled to other controllers (e.g., input power & electronic amplifier controller 405, electronic amplifier controller 705, etc.) in addition to, or instead of coupling to, the input power controller 130. In some embodiments, a signal monitor 125 is installed at the output of each AMP 155. Alternatively, a signal monitor 125 may be installed at the output of the receiving device.

Input power controller 130 is configured to monitor the sensor output signals received from each electronic signal monitor 125. The input power controller 130 is configured to analyze the sensor output signals to determine a channel feedback signal. Note, because the selected channel power is dominant in the output signals 160, the channel feedback signal is based on the selected channel power and mostly independent of the other WDM channels. The channel feedback signal may be, for example, one of the sensor output signals, the maximum of the sensor output signals, the average of sensor output signals, or some other derivative of the sensor output signals. As discussed in detail below, the input power controller 130 is configured to determine what adjustment instructions are sent to power adjustment device 110 based on a comparison between the channel feedback signal and a calibrated signal value.

Target settings controller 135 is configured to supply calibration settings to the electronic amplifier controller 120 and the input power controller 130. Calibration settings may include, for example, a target gain value, G_{AMP}_{_{—}}ₛₑₜ, for each AMP 155, a calibrated signal value, an initial adjustment instruction for the power adjustment device 110, or some combination thereof. The calibration settings are set such that the voltages of the electrical output signals 160 equal an optimal voltage Vₒₚₜ of the receiving device (not shown). Additionally, the gain values for each AMP 155 may be set such that the power of the output signals 160 are equalized. In some embodiments, the calibration settings may be dynamically adjusted.

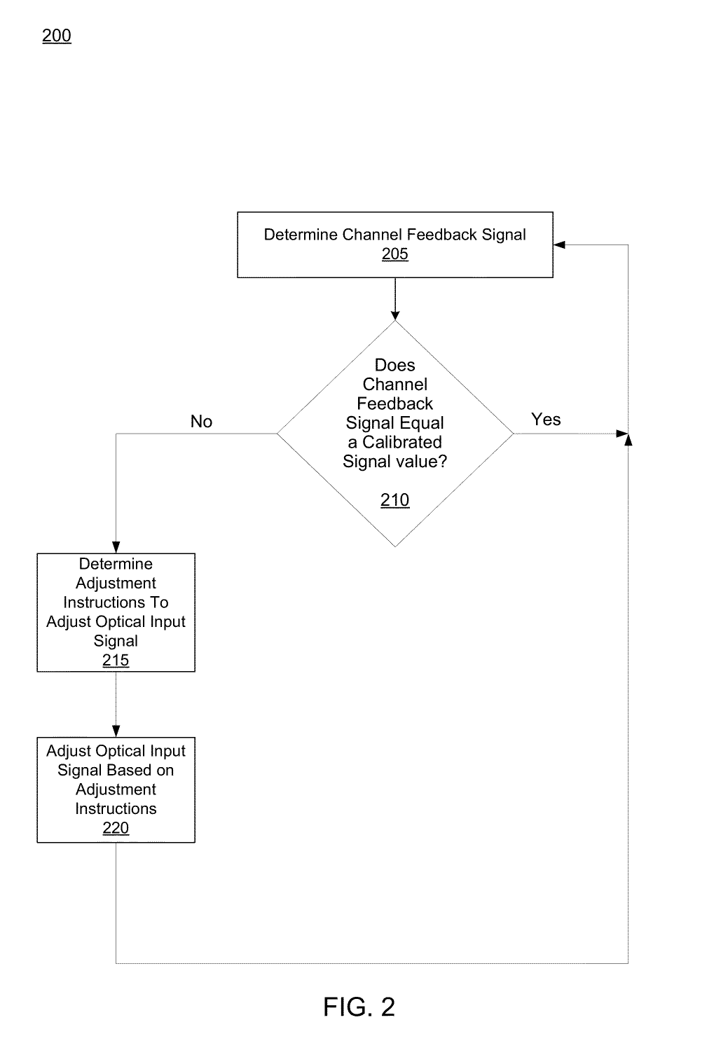

FIG. 2 is a flow diagram illustrating an example process 200 performed by an optical receiver system (e.g., optical receiver system 100) operating as a fast optical loop feedback Rx control system. The optical receiver system determines (205) a channel feedback signal. For example, the optical receiver system monitors sensor output signals from electronic signal monitors 125 to determine if a signal is present. If a signal is present, the optical receiver system calculates a channel feedback signal using the sensor output signals.

The optical receiver system then determines (210) whether the channel feedback signal equals a calibrated signal value. The calibrated signal value is determined based on an optimal voltage Vₒₚₜ for the receiving device. Gain values for each AMP (e.g., 155) can be set fixed at G_{AMP}_{_{—}}ₛₑₜ during the calibration or can be slowly (compared to an input power controller 130 control speed) fine-adjusted around the target value G_{AMP}_{_{—}}ₛₑₜ during the operation to equalize the AMPs output voltages. G_{AMP}_{_{—}}ₛₑₜ may be determined by P_{Ds}_{_{—}}_{ch}_{_{—}}_{tgt} (the optical target power of the selected channel after a power adjustment device (e.g., power adjustment device 110)) to achieve the optimum signal voltage at the outputs of the AMPs. If the channel feedback signal equals the calibrated value, the optical receiver system then moves to step 205 and the process continues as described.

If the channel feedback signal is not equal to the calibrated signal value, the optical receiver system determines (215) adjustment instructions to adjust the power of the optical input signal. The optical receiver system determines adjustment instructions by comparing the calibrated signal value with the channel feedback signal. If the channel feedback signal is greater than the calibrated signal value, the adjustment instructions increase the amount of attenuation of the optical input signal. If the channel feedback signal is less than the calibrated signal value, the adjustment instructions reduce the amount of attenuation of the optical input signal. The optical receiver system then adjusts (220) the optical input signal based on the adjustment instructions. For example, an input power controller may send the power adjustment device adjustment instructions causing it to perform the instructed level of adjustment. The process flow then moves to step 205 and the process continues as described.

This mode of operation generally works well in the presence of optical signal transients when a fast VOA is used (μS or faster response) as the power adjustment device. The method can be used to extend the low-penalty receiver operation to the high-power range of the selected channel.

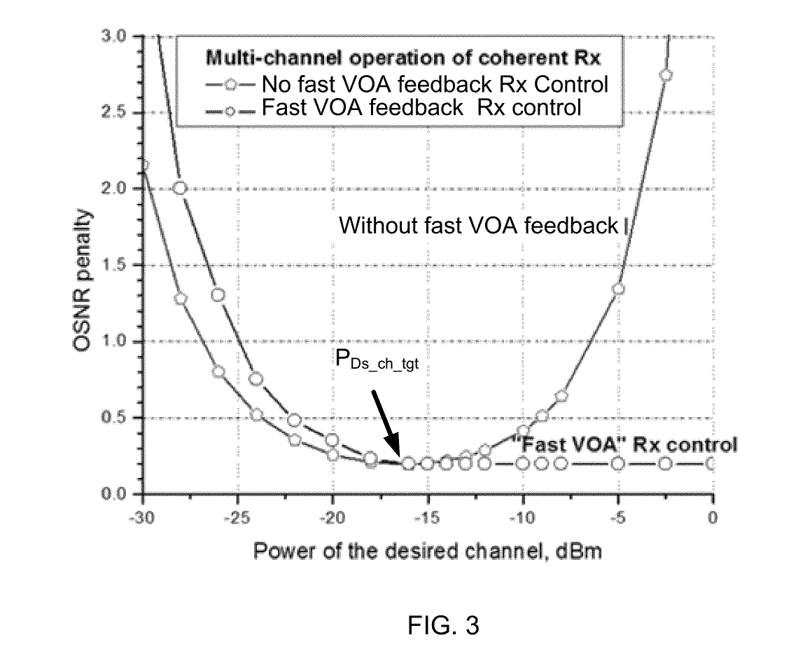

As discussed above, in some embodiments power adjustment device 110 is a VOA. VOAs are capable of only attenuation and cannot provide amplification. FIG. 3 is a graph showing multi-channel operation of a coherent Rx with, and without fast VOA feedback Rx control. The power of the desired channel is measured after the power adjustment device. The optical signal-to-noise ratio (OSNR) penalty depends on, for example, the number of channels, the electrical power of the WDM channels and the power of the selected channel. In this embodiment, the calibrated signal value is such that when the channel feedback signal equals the calibrated signal value, the power of the coherent optical receiver's input signal is P_{DS}_{_{—}}_{ch}_{_{—}}_{tgt}. If the channel feedback signal is greater than the calibrated signal value, the input power controller 130 is configured to send adjustment instructions to the power adjustment device 110 to increase attenuation of the optical input signal until the channel feedback signal is equal to the calibrated signal value. Likewise, if the channel feedback signal is less than the calibrated signal value, the input power controller 130 is configured to send adjustment instructions to the power adjustment device 110 to reduce attenuation of the optical input signal until the channel feedback signal is equal to the calibrated signal value. However, in instances where the optical input signal low enough that it actually needs to be amplified (e.g., a VOA having to produce gain) the performance of the coherent Rx without fast VOA feedback Rx control is better than the performance of the coherent Rx with fast VOA feedback Rx control. This is due to, for example, losses in the system introduced by the fast VOA feedback Rx control system, shot noise of the PDs 140, shot noise of the AMPs 155, etc.

The VOA attenuation is used to compensate for the signal transients in the optical domain and keep the signal power of the selected channel after the VOA at P_{Ds}_{_{—}}_{ch}_{_{—}}_{tgt}. P_{Ds}_{_{—}}_{ch}_{_{—}}_{tgt} is set at the calibration to achieve the widest dynamic range of the selected channel. It can be determined by the maximum possible ratio of the WDM channels power P_{WDM} to the power of the selected channel, by the receiver parameters and by other parameters.

### Fast Optical Loop Feedback and Fast AMP Receiver Control

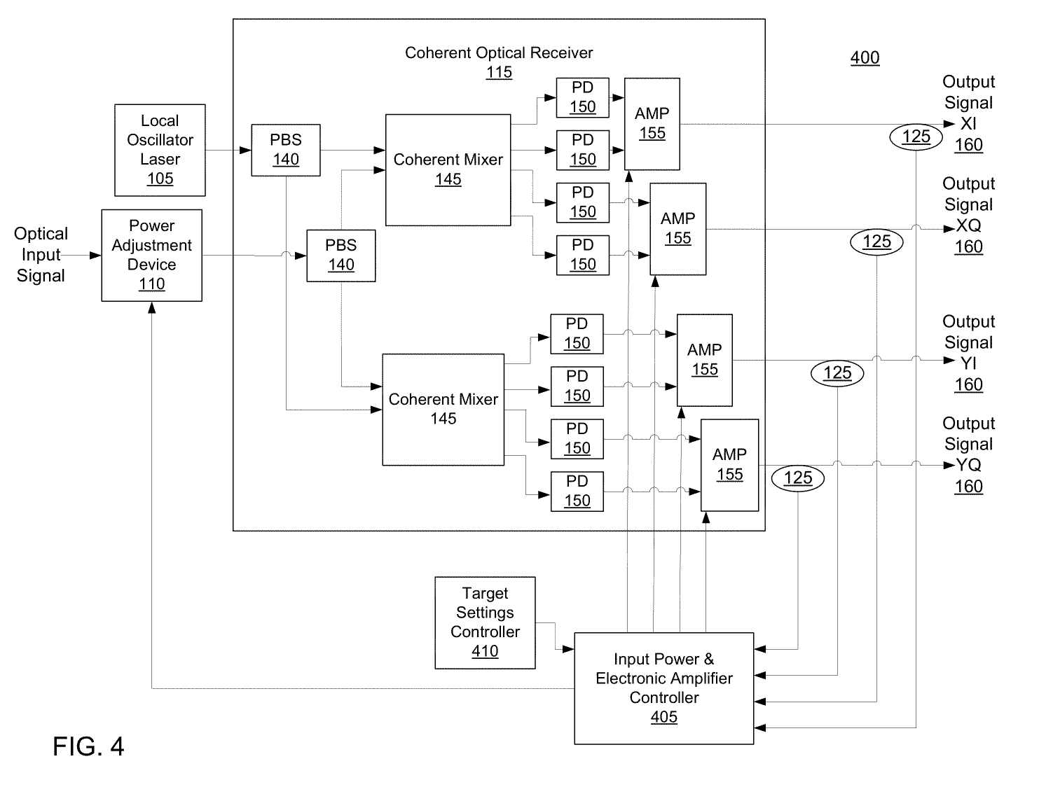

FIG. 4 is a block diagram of an example embodiment of an optical receiver system 400 configured to operate as a “fast optical loop feedback and fast AMP Rx control” system. As shown in exemplary FIG. 4, the optical receiver system 400 is similar to optical receiver system 100 described above with reference to FIG. 1, but is modified to operate as a fast optical loop feedback and fast AMP Rx control system, where the sensor output signals act as a feedback mechanism to control the power of the optical signal entering the coherent optical receiver 115 and also the gain of each AMP 155. Additionally, as used herein, “fast VOA feedback and fast AMP Rx control” refers to an embodiment of optical receiver system 400 when the power adjustment device 110 is a VOA.

In some embodiments, in the “fast VOA feedback Rx control” mechanism described above with reference to FIG. 1, when the input power of the selected channel is too low, the VOA can reach its minimum attenuation value). As a result, the fixed AMP gain G_{AMP}_{_{—}}ₛₑₜ is no longer high enough to keep the AMP output voltage at the optimum value and the performance of the optical receiver system 100 degrades. This degradation of performance may be compensated for by using the fast optical loop feedback and fast AMP Rx control system described herein.

In FIG. 4, the optical receiver system 100 is modified by combining the functionality of the electronic amplifier controller 120 and the input power controller 130 into an input power & electronic amplifier controller 405. Input power & electronic amplifier controller 405 is configured to analyze the sensor output signals to determine a channel feedback signal. The channel feedback signal may be, for example, one of the sensor output signals, the maximum of the sensor output signals, the average of sensor output signals, or some other derivative of the sensor output signals.

As discussed in detail below, the input power & electronic amplifier controller 405 is configured to send adjustment instructions to adjust gain values for one or more AMPs 155 based on a comparison between the channel feedback signal and the calibrated signal value. The adjustment instructions may cause an AMP 155 to increase, decrease, or maintain its gain value. For example, if the channel feedback signal is less than the calibrated signal value and the power adjustment device 110 would be required to amplify the optical input signal, the input power & electronic amplifier controller 405 may increase the gain values for one or more of AMPs 155. Likewise, if the channel feedback signal is greater than the calibrated signal value, input power & electronic amplifier controller 405 may send adjustment instructions that cause the power adjustment device 110 to attenuate the optical input signal. In some embodiments, one or more of the AMPS 155 or the power adjustment device 110 may be adjusted at a time. However, it is preferable that both the power adjustment device 110 and the AMPS 155 are not adjusted at the same time as it may result in instabilities in the feedback system.

Target settings controller 410 is configured to supply calibration settings to the input power & electronic amplifier controller 405. Calibration settings may include, for example, G_{AMP}_{_{—}}ₛₑₜ for each AMP 155, the calibrated signal value, an initial adjustment instruction for power adjustment device 110, or some combination thereof. The calibration settings are set based on the optimal input voltage of the receiving device (not shown).

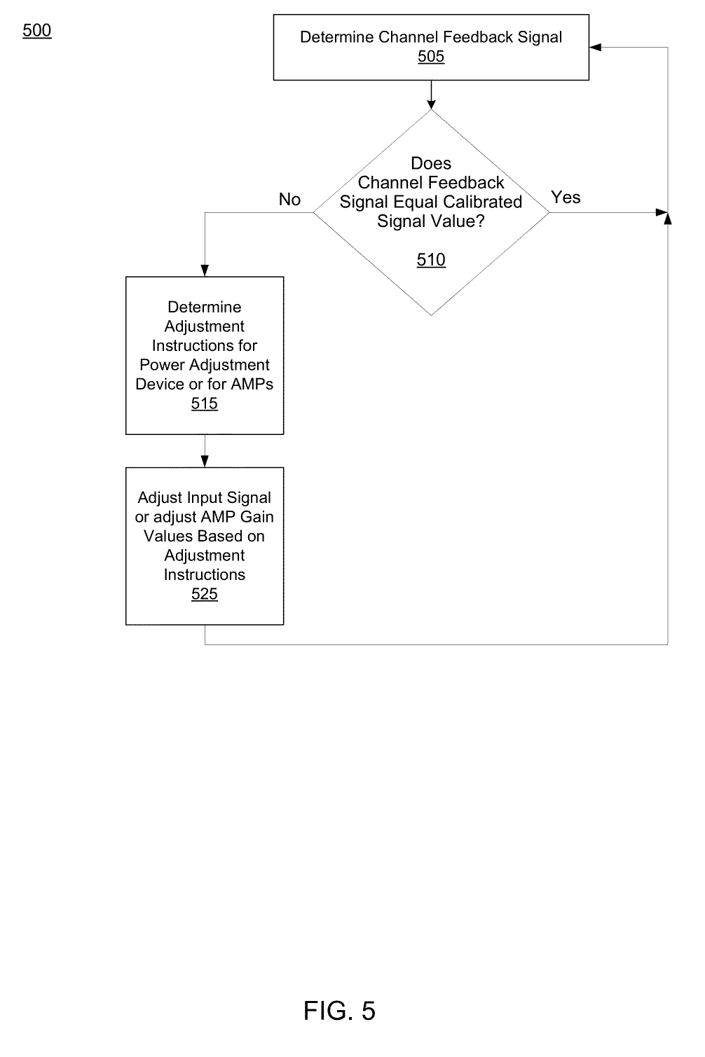

FIG. 5 is a flow diagram illustrating an example process 500 performed by an optical receiver system (e.g., optical receiver system 400) operating as a fast optical loop feedback and fast AMP Rx control system. The optical receiver system determines (505) a channel feedback signal. For example, the optical receiver system monitors sensor output signals from the electronic signal monitors 125 to determine if a signal is present. If a signal is present, the optical receiver calculates a channel feedback signal using the sensor output signals.

The optical receiver system then determines (510) whether the channel feedback signal is equal to the calibrated signal value. If the channel feedback signal equals the calibrated value, the optical receiver system then moves to step 505 and the process continues as described.

If the channel feedback signal is not equal to the calibrated signal value, the optical receiver system then determines (515) adjustment instructions for a power adjustment device (e.g., a power adjustment device 110) or for one or more AMPS (e.g., AMPs 155). The optical receiver system determines adjustment instructions by comparing the calibrated signal value with the channel feedback signal. If the channel feedback signal is greater than the calibrated signal value, the adjustment instructions are for more attenuation of the optical input signal. If the channel feedback signal is less than the calibrated signal value, the adjustment instructions are for less attenuation of the optical input signal. In cases where the power adjustment device reaches a minimum attenuation level (and would need to amplify the optical input signal), the VOA attenuation is set to a constant and the optical receiver system increases the gain of one or more of the AMPs. In some embodiments, one or more of the AMPS or the power adjustment device 110 may be adjusted at a given time. In these embodiments, if the power adjustment device is being adjusted, the optical receiver system temporarily fixes the AMP gain values. For example, the AMP gain values may be fixed at their previous values or set to a predetermined value. In some embodiments, the predetermined value may differ for one or more of the AMPs. Likewise if the gain values of the AMPs are being adjusted, the optical receiver temporarily fixes the attenuation/gain level of the power adjustment device. For example, the attenuation/gain value of the power adjustment device may be fixed at is previous value or set to a predetermined value.

Based on the adjustment instructions, the optical receiver system adjusts (525) one or more of the AMPs gain values or the gain/attenuation level of the power adjustment device. For example, an input power & electronic amplifier controller (e.g., input power & electronic amplifier controller 405) may send the power adjustment device adjustment instructions causing it to perform an instructed level of attenuation. The optical receiver system then determines moves to step 505 and continues as described.

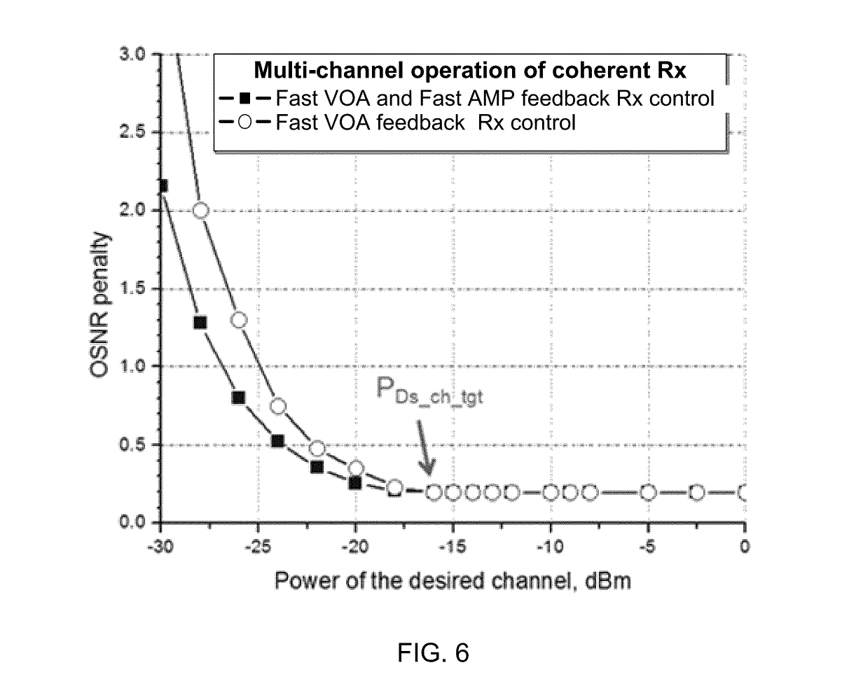

As discussed above, in some embodiments power adjustment device 110 is a VOA. FIG. 6 is a graph comparing multi-channel operation of a fast VOA feedback Rx control system (as in FIG. 1) with a fast VOA and fast AMP feedback Rx control system (as in FIG. 4). The calibrated signal value is such that when the channel feedback signal equals the calibrated signal value, the coherent optical receiver's input signal is P_{DS}_{_{—}}_{ch}_{_{—}}_{tgt}. If the channel feedback signal is greater than the calibrated signal value, the input power & electronic amplifier controller 405 is configured to send adjustment instructions to the VOA to adjust the attenuation of the optical input signal until the channel feedback signal is equal to the calibrated signal value. In cases where the VOA reaches a minimum attenuation level and would need to amplify the optical input signal, the input power & electronic amplifier controller 405 increases the gain of one or more of the AMPs 155 until the channel feedback signal is equal to calibrated signal value. As a result, optical receiver system 400 is able to compensate for variations in the optical input signal that are above and below the P_{Ds}_{_{—}}_{ch}_{_{—}}_{tgt}.

### Slow Optical Loop and Fast Electric Loop Feedback Receiver Control

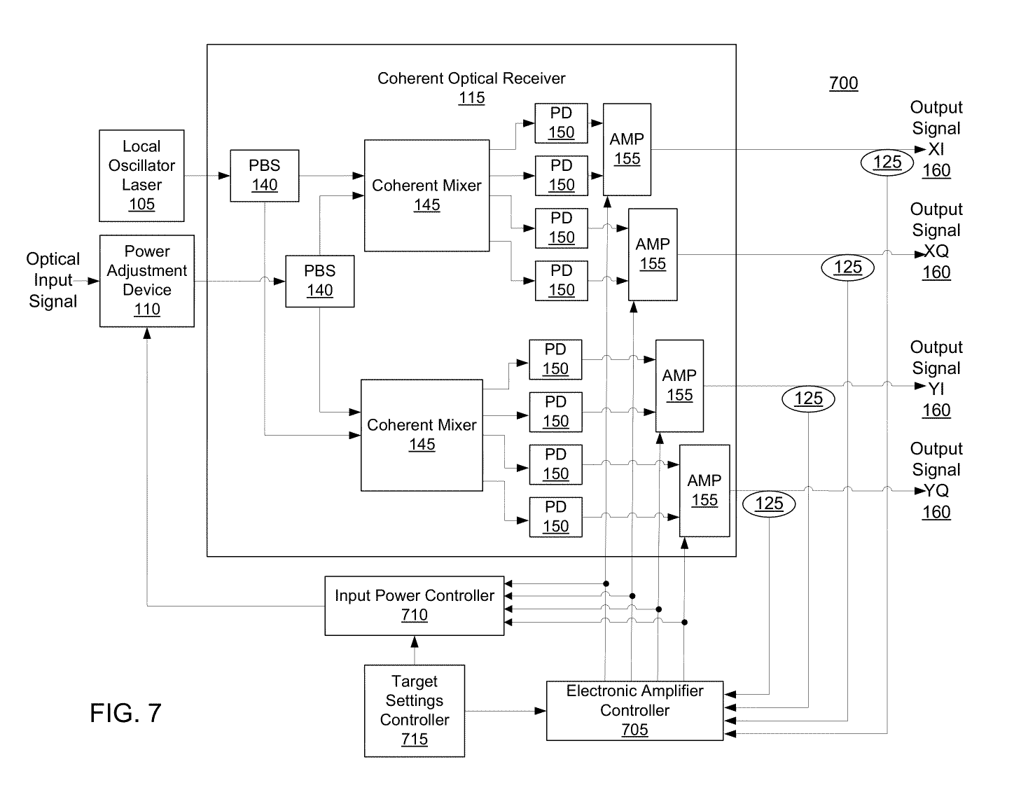

FIG. 7 is a block diagram of an example embodiment of an optical receiver system 700 configured to operate as “a slow optical loop and fast electrical loop feedback Rx control system.” As shown in exemplary FIG. 7, the optical receiver system 700 is similar to optical receiver system 100 described with reference to FIG. 1, but is modified to operate as a “slow optical loop and fast electrical loop feedback Rx control” system, where sensor output signals act as a feedback mechanism to control the gain values for each AMP 155, and an input power controller uses the AMP gain values as feedback signals to determine adjustment instructions for the power adjustment device 110. Additionally, as used herein, “slow VOA Rx control” refers to an embodiment of optical receiver system 700 when the power adjustment device 110 is a VOA.

In a slow optical loop and fast electrical loop feedback Rx control system, the AMP gain values are used to accomplish suppression of transient optical input signals. The power adjustment device 110 is controlled at the same time but on a slower time scale (compared to the AMP gain feedback loop) for the purpose of setting P_{DS}_{_{—}}_{ch}_{_{—}}_{tgt} at the power adjustment device 110 output.

In FIG. 7, the optical receiver system 100 is modified such that fast AMP feedback loops use the feedback signals from electronic signal monitors 125, and a slow power adjustment device feedback loop uses the AMPs 155 gain values as the feedback. The electronic amplifier controller 705 is configured to determine a channel feedback signal. The channel feedback signal may be, for example, one of the sensor output signals, the maximum of the sensor output signals, the average of sensor output signals, or some other derivative of the sensor output signals. The electronic amplifier controller 705 is configured to adjust gain values for each AMP 155 based on a comparison between a channel feedback signal and a calibrated signal value. For example, if a channel feedback signal is less than the calibrated signal value, electronic amplifier controller 705 may increase the gain settings for one or more of AMPs 155. Likewise, if the channel feedback signal is greater than the calibrated signal value the electronic amplifier controller 705 may decrease the gain settings for one or more of the AMPs 155. Thus, the electronic amplifier controller 705 is able to quickly correct for transients in the power level of the output signals 106. In alternate embodiments, the optical receiver system 100 is modified such that fast AMP feedback loops use the feedback signals from the electronic signal monitors 125, and the slow power adjustment device feedback loop uses the inputs to AMPs 155 as the feedback signal.

An input power controller 710 is configured to receive and analyze the AMP gain values to determine a gain value (“GV”) feedback signal. The GV feedback signal may be, for example, one of the AMP gain values, the maximum of the AMP gain values, the average of the AMP gain values, or some other derivative of the AMP gain values. As discussed in detail below, input power controller 710 is configured to determine what adjustment instructions are sent to power adjustment device 110 based on a comparison between the GV feedback signal and a calibrated signal GV. For example, if the GV feedback signal is not equal to the calibrated signal GV, input power controller 710 may send adjustment instructions that cause power adjustment device 110 to attenuate or amplify the optical input signal.

Target settings controller 715 is configured to supply calibration settings to the input power controller 710 and the electronic amplifier controller 705. Calibration settings may include, for example, G_{AMP}_{_{—}}ₛₑₜ for each AMP 155, the calibrated signal value, the calibrated signal GV, an initial adjustment instruction for power adjustment device 110, or some combination thereof. During the calibration, the target voltages for each output signal 160 are set to the value for optimum operation of the electronics after the AMPs 155 (e.g., the receiving device). The gain targets (for the power device feedback loop) for each AMP 155 are set to achieve the optimum average optical power of the selected channel at the output of power adjustment device 110. The relationship between the AMP output voltage V_{AMP}_{_{—}}ₒᵤₜ, the AMP gain G_{AMP}, the optical power of the local oscillator P_{LO}, the optical power of the selected channel power P_{DS}_{_{—}}_{after}_{_{—}}_{VOA} and the receiver responsivity R can be related as follows:

V_{AMP}_{_{—}}ₒᵤₜ=G_{AMP}*R*(P_{LO}*P_{DS}_{_{—}}_{after}_{_{—}}_{VOA})^{0.5} (1)

The AMP gain targets can be calculated from

G_{AMP}=V_{AMP}_{_{—}}ₒᵤₜ/(R*(P_{LO}*P_{DS}_{_{—}}_{after}_{_{—}}_{VOA})^{0.5}) (2)

by substituting the optimum=V_{AMP}_{_{—}}ₒᵤₜ and the optimum value of the average optical power of the selected channel into this equation.

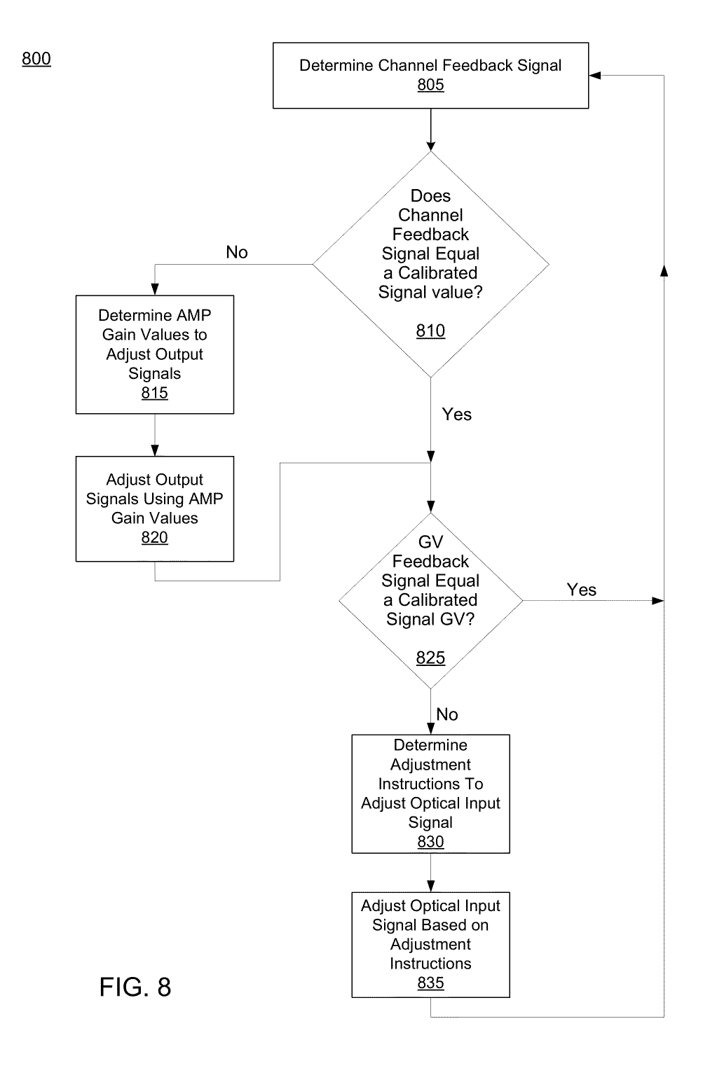

FIG. 8 is a flow diagram illustrating an example process 800 performed by an optical receiver system (e.g., optical receiver system 700) operating as a slow optical loop and fast electrical loop feedback Rx control system. The optical receiver system determines (805) a channel feedback signal. For example, the optical receiver system monitors sensor output signals from the electronic signal monitors 125 to determine if a signal is present. When the sensor output signals are present, the optical calculates a channel feedback signal using the sensor output signals.

The optical receiver system determines (810) whether the channel feedback signal is equal to the calibrated signal value. If the RF feedback value does not equal the calibrated signal value, the optical receiver system determines (815) AMP gain values to adjust the output signals. For example, if the channel feedback signal is greater than the calibrated signal value, the optical receiver system is configured to determine AMP gain values for one or more of the AMPS (e.g., AMPs 155) to increase attenuation of the output signals until the channel feedback signal is equal to the calibrated signal value. Likewise, if the channel feedback signal is less than the calibrated signal value, the optical receiver system is configured to determine AMP gain values for one or more of the AMPs 155 to reduce attenuation of the output signals until the channel feedback signal is equal to the calibrated signal value. The optical receiver system adjusts (820) the output signals using the determined AMP gain values. If the channel feedback signal equals the calibrated signal value, the optical receiver system moves to step 825.

In step 825 the optical receiver system determines whether a GV feedback signal is equal to a calibrated signal GV. If the GV feedback signal equals the calibrated signal GV, the process flow then moves to step 805. But, if the GV feedback signal is not equal to the calibrated signal GV, the optical receiver system determines (830) adjustment instructions to adjust the optical input signal using the power adjustment device (e.g., power adjustment device 110). For example, the optical receiver system determines adjustment instructions by comparing the calibrated signal GV with the GV feedback signal. If the GV feedback signal is greater than the calibrated signal GV, the adjustment instructions are for more attenuation of the optical input signal. If the GV feedback signal is less than the calibrated signal GV, the adjustment instructions are for less attenuation of the optical input signal. The GV feedback signal may be, for example, one of the AMP gain values, the maximum of the AMP gain values, the average of the AMP gain values, or some other derivative of the AMP gain values. The optical receiver system adjusts (835) the optical input signal based on the determined adjustment instructions using the power adjustment device. The process flow then moves to step 805.

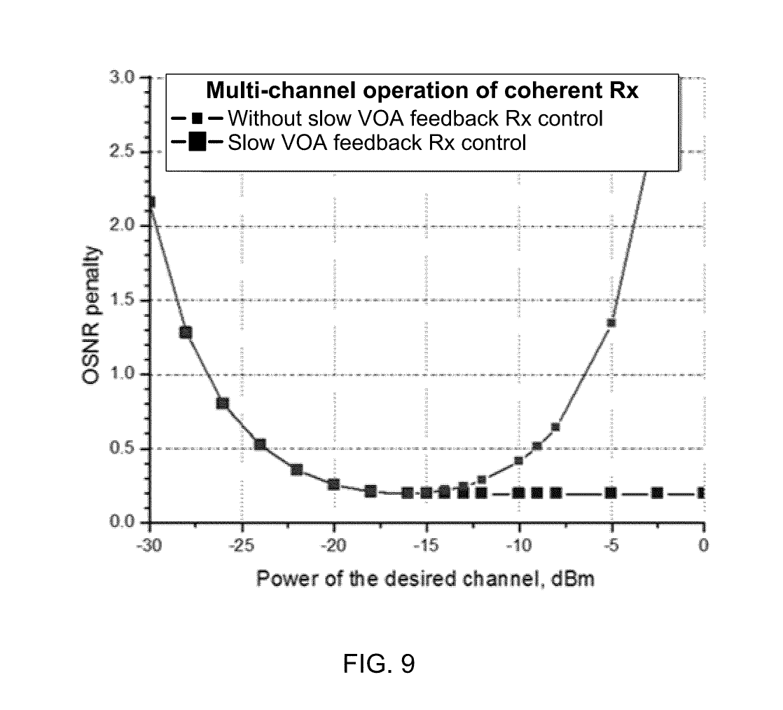

As discussed above, in some embodiments the power adjustment device 110 is a VOA. FIG. 9 is a graph showing multi-channel operation of a coherent Rx with, and without slow VOA feedback Rx control, in accordance with an embodiment. FIG. 9 illustrates that the embodiment described is able to maintain minimal optical signal-to-noise over a broader range than a typical coherent optical receiver.

### ADDITIONAL EMBODIMENTS

The approaches described above were implemented using coherent receivers. In alternate embodiments, the above approaches described above may be used with non-coherent receivers.

As previously noted, the power adjustment device is not limited to being a VOA, but may also be a variable gain optical amplifier. Use of a variable gain optical amplifier may also improve the performance of one or more of the above optical receiver systems when the power of the optical input signal is low. In embodiments, where the power adjustment device 110 is a variable gain optical amplifier it is important to note that the variable gain optical amplifier may also be configured to mimic the functionality of a VOA. For example, this may be useful in cases where a variable gain optical amplifier already exists in the system.

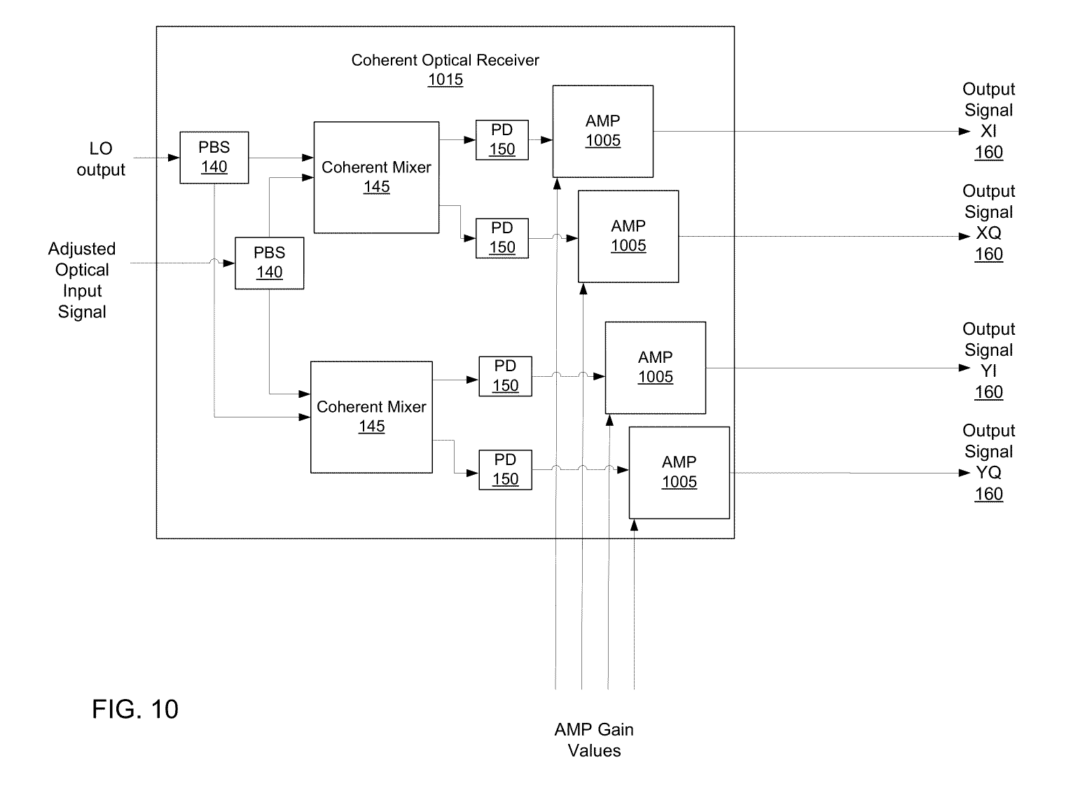

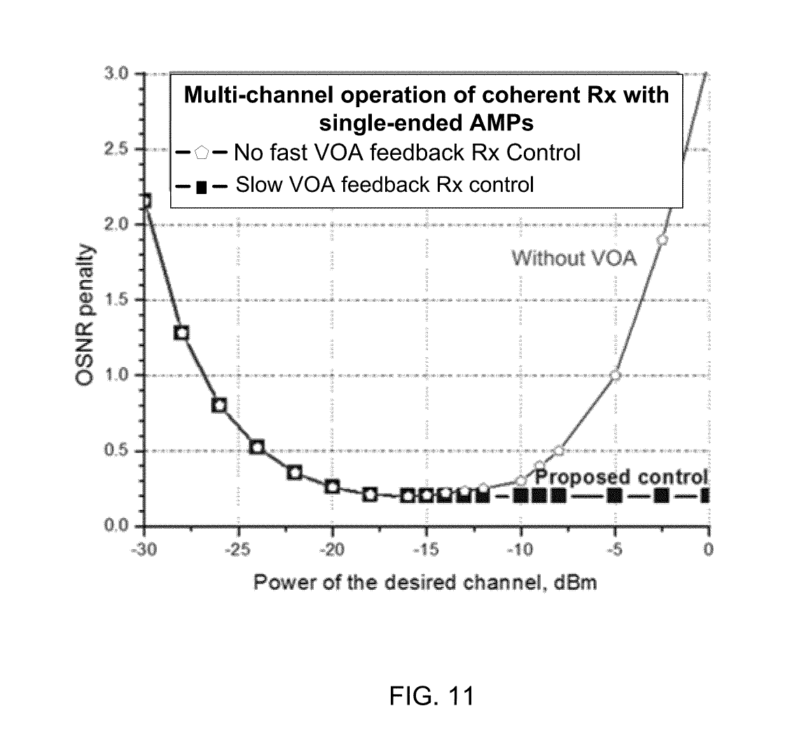

The approaches described above were implemented using differential electronic amplifiers. In alternate embodiments, any of the above approaches may be used with single ended AMPs instead of differential AMPs 155. FIG. 10 is a block diagram of an example embodiment of an optical receiver 1015 utilizing single ended AMPs 1005. The signal monitors, controllers and power adjustment device in the larger system are not shown in FIG. 10. Additionally, because single ended AMPs 1005 are used, the coherent optical receiver 1015 is configured to utilize four PDs 150. For example, FIG. 11 is a graph showing multi-channel operation of a coherent Rx using single-ended AMPs with and without slow VOA feedback Rx control, in accordance with an embodiment.

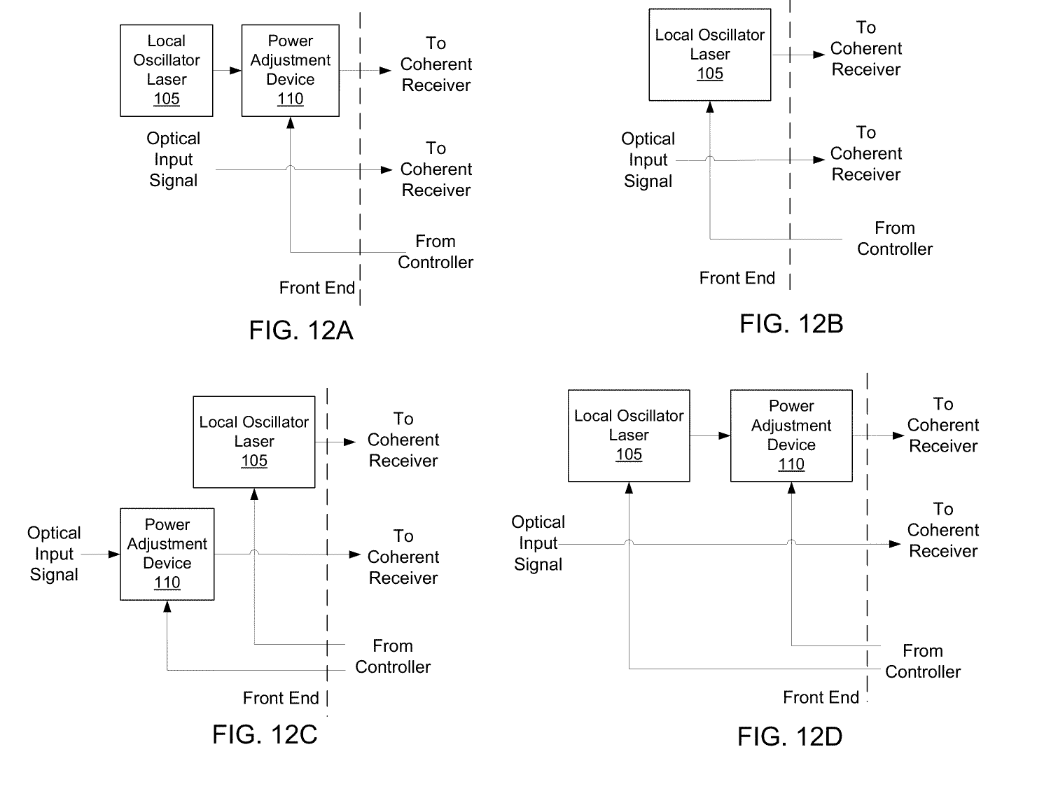

Also in the multichannel embodiments described above, each output signal 160 is proportional to the selected channel power and the power of the output of LO laser 105. Additionally, each sensor output signal is proportional to its corresponding output signal 160. Accordingly, each sensor output signal is also proportional to the selected channel power and the power of the output of LO laser 105. Thus, in alternate embodiments, one can control the power of the LO instead of (or in addition to) controlling (or using) the power adjustment device 110. The power of the LO laser 105 can be varied with, for example, a dedicated power adjustment device 110 or using the LO laser 105 power itself FIG. 12A is a block diagram of an example embodiment of a front end of an optical receiver system where the output of the LO laser 105 is adjusted using a dedicated power adjustment device 110. In this embodiment, adjustment instructions are sent from a controller (e.g., input power controller 130, input power & electronic amplifier controller 405, input power controller 710, etc.) that sends adjustment instructions to the power adjustment device 110. FIG. 12B is a block diagram of an example embodiment of a front end of an optical receiver system where the output of the LO laser 105 is adjusted by varying the LO laser 105 power itself FIG. 12C is a block diagram of an example embodiment of a front end of an optical receiver system where the output of the LO laser 105 is adjusted by varying the LO laser 105 power itself and the power of the optical input signal is adjusted using the power adjustment device 110. FIG. 12D is a block diagram of an example embodiment of a front end of an optical receiver system where the output of the LO laser 105 is adjusted by varying the LO laser 105 power itself and a dedicated power adjustment device 110. In some embodiments, not shown, FIG. 12D may be modified to also include an additional power adjustment device 110 that is used to adjust the power of the optical input signal.

Although the detailed description contains many specifics, these should not be construed as limiting the scope of the disclosure but merely as illustrating different examples and aspects of the disclosure. It should be appreciated that the scope of the disclosure includes other embodiments not discussed in detail above. For example, in the cases of a single-WDM channel operation (i.e. non-ORT mode) of the receiver (coherent or non-coherent), one can use the optical signal strength after the power adjustment device 110 instead of the output from the RF signal detector 125 as a feedback signal in the above cases. Persons skilled in the relevant art can appreciate that many modifications and variations are possible in light of the above disclosure.

In the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

Each controller (e.g., target settings controller, input power controller, electronic amplifier controller, input power & electronic amplifier controller) may be implemented in computer hardware, firmware, software, and/or combinations thereof. Each computer program can be implemented in a high-level procedural or object-oriented programming language, or in assembly or machine language if desired; and in any case, the language can be a compiled or interpreted language. Suitable processors include, by way of example, both general and special purpose microprocessors. Any of the foregoing can be supplemented by, or incorporated in, ASICs (application-specific integrated circuits) and other forms of hardware.

What is claimed is:

1. An optical receiver system comprising:
a power adjustment device that adjusts a power of an optical multi-channel input signal in accordance with adjustment instructions, the optical multi-channel input signal comprising multiple channels of data at different wavelengths;
an optical receiver which converts the power-adjusted optical multi-channel input signal into an electrical single-channel output signal that corresponds to a selected channel from among the multiple channels, wherein the optical receiver includes an electronic amplifier that produces the electrical single-channel output signal and the optical receiver is characterized by a preferred output voltage Vₒₚₜ for the electrical single-channel output signal; and
a controller that determines the adjustment instructions in response to the electrical single-channel output signal, the adjustment instructions causing the power adjustment device to adjust the power of the optical multi-channel input signal to a target optical power level corresponding to the preferred output voltage Vₒₚₜ of the electrical single-channel output signal.

2. The optical receiver system of claim 1, wherein the preferred output voltage Vₒₚₜ for the electrical single-channel output signal is a preferred input voltage for amplifier receiving device.

3. The optical receiver system of claim 1, wherein the preferred output voltage Vₒₚₜ minimizes an OSNR penalty for the optical receiver system.

4. The optical receiver system of claim 1, wherein the power adjustment device is a variable optical attenuator.

5. The optical receiver system of claim 1, wherein the power adjustment device is a variable gain optical amplifier.

6. The optical receiver system of claim 1, further comprising:
an electronic signal monitor that outputs a sensor output signal that is based on the electrical single-channel output signal; and
wherein the controller is further configured to:
determine a channel feedback signal based on the sensor output signal,
compare the channel feedback signal to a calibrated signal value, the calibrated signal value corresponding to the preferred output voltage Vₒₚₜ,
determine the adjustment instructions based on the comparison.

7. The optical receiver system of claim 1, further comprising:
an electronic signal monitor that outputs a sensor output signal that is based on the electrical single-channel output signal; and
wherein the controller and the electronic amplifier are part of a first feedback loop, and the controller and the power adjustment device are part of a second feedback loop that operates on a similar time scale as the first feedback loop, and the controller is further configured to determine an electrical gain value based on the sensor output signal and to provide the gain value to the electronic amplifier.

8. The optical receiver system of claim 7, wherein the controller is configured to, at any point in time, either adjust the electrical gain value or provide adjustment instructions to adjust a level of optical attenuation or gain of the power adjustment device.

9. The optical receiver system of claim 7, wherein the controller is configured to:
fix the electrical gain value at a predetermined gain value when providing adjustment instructions to adjust the level of optical attenuation or gain of the power adjustment device; and
fix the level of attenuation or gain of the power adjustment device at a predetermined level when adjusting the gain value of the electronic amplifier.

10. The optical receiver system of claim 9, wherein the predetermined level corresponds to a minimum level of attenuation produced by the power adjustment device.

11. The optical receiver system of claim 7, wherein the controller is configured to increase the gain of the electronic amplifier when the channel feedback signal is less than the calibrated signal value.

12. The optical receiver system of claim 1, further comprising:
an electronic signal monitor that outputs a sensor output signal that is based on the electrical single-channel output signal; and
an electronic amplifier controller configured to:
determine a channel feedback signal based on the sensor output signal,
compare the channel feedback signal to a calibrated signal value, the calibrated signal value corresponding to the preferred output voltage Vₒₚₜ,
determine a gain value for the electronic amplifier based on the comparison, and
provide the electronic amplifier with the gain value; and
wherein the electronic amplifier controller and the electronic amplifier are part of a first feedback loop, and the controller and the power adjustment device are part of a second feedback loop that operates on a slower time scale than the first feedback loop, and the controller is further configured to:
determine a gain value feedback signal using the gain value, and
determine adjustment instructions when the gain value feedback signal is not equal to a calibrated signal gain value.

13. The optical receiver system of claim 1, wherein the electronic amplifier is a single ended amplifier.

14. The optical receiver system of claim 1, wherein the electronic amplifier is a differential amplifier.

15. The optical receiver system of claim 1 wherein the optical receiver further comprises:
a local oscillator laser that produces an output tuned to the selected channel of the optical multi-channel input signal;
a first electronic signal monitor that outputs a sensor output signal that is based on the electrical single-channel output signal;
a second electronic amplifier, that produces a second electrical single-channel output signal; and
a second electronic signal monitor that outputs a second sensor output signal that is based on the second electrical single-channel output signal.

16. The optical receiver system of claim 15, wherein the controller is configured to determine a channel feedback signal using the first and second electrical single-channel output signals.

17. The optical receiver system of claim 16, wherein a channel feedback signal is selected from the group consisting of: one of the sensor output signals, the maximum of the sensor output signals, and the average of sensor output signals.

18. The optical receiver system of claim 15, further comprising:
an electronic amplifier controller configured to:
determine the second gain value; and
determine a radio frequency feedback signal using the first and second amplified electronic signals.

19. The optical receiver system of claim 15, further comprising a second power adjustment device configured to adjust a power of the output of the local oscillator laser in accordance with adjustment instructions received from the controller.

20. The optical receiver system of claim 15, wherein the controller is configured to adjust the power of the local oscillator laser in accordance with adjustment instructions received from the controller.

21. A method of operation for an optical receiver comprising:
converting a power-adjusted optical multi-channel input signal into an electrical single-channel output signal that corresponds to a selected channel from among the multiple channels, wherein the optical receiver includes an electronic amplifier that produces the electrical single-channel output signal and the optical receiver is characterized by a preferred output voltage Vₒₚₜ for the electrical single-channel output signal, and the optical multi-channel input signal comprises multiple channels of data at different wavelengths;
determining a channel feedback signal based on the electrical single-channel output signal;
comparing the channel feedback signal to a calibrated signal value, the calibrated signal value corresponding to the preferred output voltage Vₒₚₜ; and
determining adjustment instructions, by a controller, to adjust the optical multi-channel input signal, the adjustment instructions causing a power adjustment device to adjust the power of the optical multi-channel input signal to a target optical power level corresponding to the preferred output voltage Vₒₚₜ.

22. The method of claim 21, further comprising:
determining an electrical gain value, by the controller, for an electronic amplifier based on the comparison; and
providing the gain value to the electronic amplifier, wherein the controller and the electronic amplifier are part of a first feedback loop, and the controller and the power adjustment device are part of a second feedback loop that operates on a similar time scale as the first feedback loop.

23. The method of claim 21, wherein the controller, at any point in time, adjusts the electrical gain value or provides adjustment instructions to adjust a level of optical attenuation or gain of the power adjustment device.

24. The method of claim 22, further comprising:
fixing the electrical gain value at a predetermined gain value when providing adjustment instructions to adjust the level of optical attenuation or gain of the power adjustment device; and
fixing the level of attenuation or gain of the power adjustment device at a predetermined level when adjusting the gain value of the electronic amplifier.

25. A method of operation for an optical receiver comprising:
converting a power-adjusted optical multi-channel input signal into an electrical single-channel output signal that corresponds to a selected channel from among the multiple channels, wherein the optical receiver includes an electronic amplifier that produces the electrical single-channel output signal and the optical receiver is characterized by a preferred output voltage Vₒₚₜ for the electrical single-channel output signal, and the optical multi-channel input signal comprises multiple channels of data at different wavelengths;
determining a channel feedback signal based on the electrical single-channel output signal;
comparing the channel feedback signal to a calibrated signal value, the calibrated signal value corresponding to a preferred output voltage Vₒₚₜ;
determining, by an electronic amplifier controller, a gain value for an electronic amplifier based on the comparison;
adjusting the level of the electrical single-channel output signal using the gain value;
determining a feedback signal using an electrical signal;
determining, by a controller, adjustment instructions to adjust the optical multi-channel input signal when the feedback signal is not equal to a calibrated value, the adjustment instructions causing a power adjustment device to adjust the power of the optical multi-channel input signal until the electrical signal equals the calibrated signal value, wherein the electronic amplifier controller and the electronic amplifier are part of a first feedback loop, and the controller and the power adjustment device are part of a second feedback loop that operates on a slower time scale than the first feedback loop; and
adjusting the power level of the optical multi-channel input signal based on the adjustment instructions.

26. The method of claim 25, wherein the electrical signal is determined using the gain value.

27. The method of claim 25, wherein the electrical signal is determined using an electrical input signal to the electronic amplifier.
